(19) United States
(12) Patent Application Publication
(10) Pub. No.: US 2024/0211014 A1
(43) Pub. Date: Jun. 27, 2024

(54) POWER-AWARE, HISTORY-BASED GRAPHICS POWER OPTIMIZATION

(71) Applicant: Advanced Micro Devices, Inc., Santa Clara, CA (US)

(72) Inventors: Tzyy-Juin Kao, Santa Clara, CA (US); Ashish Jain, Austin, TX (US); Rashad Oreifej, Orlando, FL (US)

(21) Appl. No.: 18/146,733

(22) Filed: Dec. 27, 2022

(51) Int. Cl. G06F 1/324; G06F 1/3218

(52) U.S. Cl. CPC G06F 1/324; G06F 1/3218

(57) ABSTRACT

Systems, apparatuses, and methods for implementing efficient power optimization in a computing system are disclosed. A system management unit records operating frequencies required for a computing component to execute a first task. The system management unit stores the recorded operating frequencies in a data array or any other predetermined memory location of a computing system. The system management unit uses the recorded operating frequencies to determine operating frequencies for execution of one or more other tasks.

### BACKGROUND

### Description of the Related Art

During the design of a computer or other processor-based system, many design factors must be considered. A successful design requires a variety of tradeoffs between power consumption, performance, thermal output, and so on. For example, the design of a computer system with an emphasis on high performance allows for greater power consumption. Conversely, the design of a portable computer system that is sometimes powered by a battery may emphasize reducing power consumption at the expense of some performance. Whatever the particular design goals, a computing system typically has a given amount of power available to it during operation. This power must be allocated amongst the various components within the system—a portion is allocated to the central processing unit, another portion to the memory subsystem, a portion to a graphics processing unit, and so on. How the power is allocated amongst the system components may also change during operation.

While it is understood that power must be allocated within a system, how the power is allocated can significantly affect system performance. For example, if too much of the system power budget is allocated for tasks that in turn provide minimal performance enhancement, the power allocation is inefficient. Similarly, for devices wherein power saving is paramount, if power allocation is done solely based on performance improvement, this could also lead to unfavorable results. Conventionally, power allocation units in computing systems may allocate power by simply using parameters available at the time of execution of a task, without necessarily considering allocation efficiency and/or sensitivity of processing units to power state changes.

In view of the above, improved systems and methods for efficient allocation of power to processing systems are required.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram of another implementation of a computing system.

FIG. 3 is a block diagram of a one implementation of a task scheduler.

FIG. 4 is a block diagram of one implementation of a system management unit.

FIG. 5 illustrates a method for recording one or more parameters of a task scheduled to be executed.

FIG. 6 illustrates a method for executing one or more tasks based on recorded parameters.

FIG. 7 illustrates a timeline graph depicting changes in operating frequencies during rendering of frames.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for implementing efficient power optimization in a computing system are disclosed. A system management unit records operating frequencies at which a computing component, such as a central processing unit (CPU) or a graphics processing unit (GPU), operates to execute a first task. The operating frequency, in an example, is indicative of a clock speed of the CPU or GPU. The system management unit stores the recorded operating frequencies in a data array or any other predetermined memory location of a computing system. The system management unit then uses the recorded operating frequencies to determine operating frequencies for execution of one or more other tasks. In doing so, the computing component optimizes power expended for performing the one or more other tasks. For instance, during execution of a second task similar to the first task (e.g., rendering of consecutive frames in a scene), the computing component operates at a threshold operating frequency, without consuming additional power, the threshold operating frequency determined using the recorded operating frequencies. Further, the computing component consumes additional power for tasks when increasing the power consumption provides a greater performance improvement. As an example, a system management unit may be a system management circuit or system management circuitry.

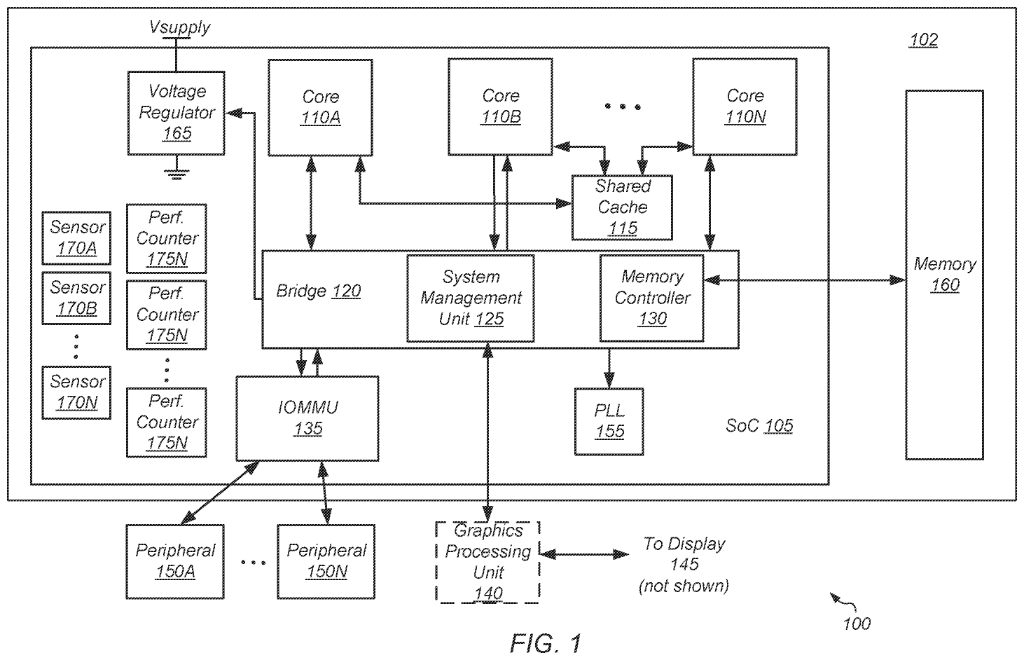

Referring now to FIG. 1, a block diagram of one implementation of a computing system 100 is shown. In this implementation, the illustrated computing system 100 includes system on chip (SoC) 105 coupled to memory 160. However, implementations in which one or more of the illustrated components of the SoC 105 are not integrated onto a single chip are possible and are contemplated. In some implementations, SoC 105 includes a plurality of processor cores 110A-N and GPU 140. In the illustrated implementation, the SoC 105, Memory 160, and other components (not shown) are part of a system board 102, and one or more of the peripherals 150A-150N and GPU 140 are discrete entities (e.g., daughter boards, etc.) that are coupled to the system board 102. In other implementations, GPU 140 and/or one or more of Peripherals 150 may be permanently mounted on board 102 or otherwise integrated into SoC 105. It is noted that processor cores 110A-N can also be referred to as processing units or processors. Processor cores 110A-N and GPU 140 are configured to execute instructions of one or more instruction set architectures (ISAs), which can include operating system instructions and user application instructions. These instructions include memory access instructions which can be translated and/or decoded into memory access requests or memory access operations targeting memory 160.

In another implementation, SoC 105 includes a single processor core 110. In multi-core implementations, processor cores 110 can be identical to each other (i.e., symmetrical multi-core), or one or more cores can be different from others (i.e., asymmetric multi-core). Each processor core 110 includes one or more execution units, cache memories, schedulers, branch prediction circuits, and so forth. Furthermore, each of processor cores 110 is configured to assert requests for access to memory 160, which functions as main memory for computing system 100. Such requests include read requests, and/or write requests, and are initially received from a respective processor core 110 by bridge 120. Each processor core 110 can also include a queue or buffer that holds in-flight instructions that have not yet completed execution. This queue can be referred to herein as an “instruction queue.” Some of the instructions in a processor core 110 can still be waiting for their operands to become available, while other instructions can be waiting for an available arithmetic logic unit (ALU). The instructions which are waiting on an available ALU can be referred to as pending ready instructions. In one implementation, each processor core 110 is configured to track the number of pending ready instructions.

Input/output memory management unit (IOMMU) 135 is coupled to bridge 120 in the implementation shown. In one implementation, bridge 120 functions as a northbridge device and IOMMU 135 functions as a southbridge device in computing system 100. In other implementations, bridge 120 can be a fabric, switch, bridge, any combination of these components, or another component. A number of different types of peripheral buses (e.g., peripheral component interconnect (PCI) bus, PCI-Extended (PCI-X), PCIE (PCI Express) bus, gigabit Ethernet (GBE) bus, universal serial bus (USB)) can be coupled to IOMMU 135. Various types of peripheral devices 150A-N can be coupled to some or all of the peripheral buses. Such peripheral devices 150A-N include (but are not limited to) keyboards, mice, printers, scanners, joysticks or other types of game controllers, media recording devices, external storage devices, network interface cards, and so forth. At least some of the peripheral devices 150A-N that are coupled to IOMMU 135 via a corresponding peripheral bus can assert memory access requests using direct memory access (DMA). These requests (which can include read and write requests) are conveyed to bridge 120 via IOMMU 135.

In some implementations, SoC 105 includes a graphics processing unit (GPU) 140 configured to be coupled to display 145 (not shown) of computing system 100. In some implementations, GPU 140 is an integrated circuit that is separate and distinct from SoC 105. GPU 140 performs various video processing functions and provides the processed information to display 145 for output as visual information. GPU 140 can also be configured to perform other types of tasks scheduled to GPU 140 by an application scheduler. GPU 140 includes a number ‘N’ of compute units for executing tasks of various applications or processes, with ‘N’ a positive integer. The ‘N’ compute units of GPU 140 is also be referred to as “processing units”. Each compute unit of GPU 140 is configured to assert requests for access to memory 160.

In one implementation, memory controller 130 is integrated into bridge 120. In other implementations, memory controller 130 is separate from bridge 120. Memory controller 130 receives memory requests conveyed from bridge 120. Data accessed from memory 160 responsive to a read request is conveyed by memory controller 130 to the requesting agent via bridge 120. Responsive to a write request, memory controller 130 receives both the request and the data to be written from the requesting agent via bridge 120. If multiple memory access requests are pending at a given time, memory controller 130 arbitrates between these requests. For example, memory controller 130 can give priority to critical requests while delaying non-critical requests when the power budget allocated to memory controller 130 restricts the total number of requests that can be performed to memory 160.

In some implementations, memory 160 includes a plurality of memory modules. Each of the memory modules includes one or more memory devices (e.g., memory chips) mounted thereon. In some implementations, memory 160 includes one or more memory devices mounted on a motherboard or other carrier upon which SoC 105 is also mounted. In some implementations, at least a portion of memory 160 is implemented on the die of SoC 105 itself. Implementations having a combination of the aforementioned implementations are also possible and contemplated. In one implementation, memory 160 is used to implement a random access memory (RAM) for use with SoC 105 during operation. The RAM implemented can be static RAM (SRAM) or dynamic RAM

(DRAM). The type of DRAM that is used to implement memory 160 includes (but are not limited to) double data rate (DDR) DRAM, DDR2 DRAM, DDR3 DRAM, and so forth.

Although not explicitly shown in FIG. 1, SoC 105 can also include one or more cache memories that are internal to the processor cores 110. For example, each of the processor cores 110 can include an L1 data cache and an L1 instruction cache. In some implementations, SoC 105 includes a shared cache 115 that is shared by the processor cores 110. In some implementations, shared cache 115 is a level two (L2) cache. In some implementations, each of processor cores 110 has an L2 cache implemented therein, and thus shared cache 115 is a level three (L3) cache. Cache 115 can be part of a cache subsystem including a cache controller.

In one implementation, system management unit 125 is integrated into bridge 120. In other implementations, system management unit 125 can be separate from bridge 120 and/or system management unit 125 can be implemented as multiple, separate components in multiple locations of SoC 105. System management unit 125 is configured to manage the power states of the various processing units of SoC 105. In one implementation, system management unit 125 uses dynamic voltage and frequency scaling (DVFS) to change the frequency and/or voltage of a processing unit to limit the processing unit's power consumption to a chosen power allocation.

SoC 105 includes multiple temperature sensors 170A-N, which are representative of any number of temperature sensors. It should be understood that while sensors 170A-N are shown on the left-side of the block diagram of SoC 105, sensors 170A-N can be spread throughout the SoC 105 and/or can be located next to the major components of SoC 105 in the actual implementation of SoC 105. In one implementation, there is a sensor 170A-N for each core 110A-N, compute unit of GPU 140, and other major components. In this implementation, each sensor 170A-N tracks the temperature of a corresponding component. In another implementation, there is a sensor 170A-N for different geographical regions of SoC 105. In this implementation, sensors 170A-N are spread throughout SoC 105 and located so as to track the temperatures in different areas of SoC 105 to monitor whether there are any hot spots in SoC 105. In other implementations, other schemes for positioning the sensors 170A-N within SoC 105 are possible and are contemplated.

SoC 105 also includes multiple performance counters 175A-N, which are representative of any number and type of performance counters. It should be understood that while performance counters 175A-N are shown on the left-side of the block diagram of SoC 105, performance counters 175A-N can be spread throughout the SoC 105 and/or can be located within the major components of SoC 105 in the actual implementation of SoC 105. For example, in one implementation, each core 110A-N includes one or more performance counters 175A-N, memory controller 130 includes one or more performance counters 175A-N, GPU 140 includes one or more performance counters 175A-N, and other performance counters 175A-N are utilized to monitor the performance of other components. Performance counters 175A-N can track a variety of different performance metrics, including the instruction execution rate of cores 110A-N and GPU 140, consumed memory bandwidth, row buffer hit rate, cache hit rates of various caches (e.g., instruction cache, data cache), and/or other metrics.

In one implementation, SoC 105 includes a phase-locked loop (PLL) unit 155 coupled to receive a system clock signal. PLL unit 155 includes a number of PLLs configured to generate and distribute corresponding clock signals to each of processor cores 110 and to other components of SoC 105. In one implementation, the clock signals received by each of processor cores 110 are independent of one another. Furthermore, PLL unit 155 in this implementation is configured to individually control and alter the frequency of each of the clock signals provided to respective ones of processor cores 110 independently of one another. The frequency of the clock signal received by any given one of processor cores 110 can be increased or decreased in accordance with power states assigned by system management unit 125. The various frequencies at which clock signals are output from PLL unit 155 correspond to different operating points for each of processor cores 110. Accordingly, a change of operating point for a particular one of processor cores 110 is put into effect by changing the frequency of its respectively received clock signal.

An operating point for the purposes of this disclosure can be defined as an operating frequency (or clock frequency), and can also include an operating voltage (e.g., supply voltage provided to a functional unit). Increasing an operating point for a given functional unit can be defined as increasing the frequency of a clock signal provided to that unit and can also include increasing its operating voltage. Similarly, decreasing an operating point for a given functional unit can be defined as decreasing the clock frequency, and can also include decreasing the operating voltage. Limiting an operating point can be defined as limiting the clock frequency and/or operating voltage to specified maximum values for particular set of conditions (but not necessarily maximum limits for all conditions). Thus, when an operating point is limited for a particular processing unit, it can operate at a clock frequency and operating voltage up to the specified values for a current set of conditions, but can also operate at clock frequency and operating voltage values that are less than the specified values.

In the case where changing the respective operating points of one or more processor cores 110 includes changing of one or more respective clock frequencies, system management unit 125 changes the state of digital signals provided to PLL unit 155. Responsive to the change in these signals, PLL unit 155 changes the clock frequency of the affected processing core(s) 110. Additionally, system management unit 125 can also cause PLL unit 155 to inhibit a respective clock signal from being provided to a corresponding one of processor cores 110.

In the implementation shown, SoC 105 also includes voltage regulator 165. In other implementations, voltage regulator 165 can be implemented separately from SoC 105. Voltage regulator 165 provides a supply voltage to each of processor cores 110 and to other components of SoC 105. In some implementations, voltage regulator 165 provides a supply voltage that is variable according to a particular operating point. In some implementations, each of processor cores 110 shares a voltage plane. Thus, each processing core 110 in such an implementation operates at the same voltage as the other ones of processor cores 110. In another implementation, voltage planes are not shared, and thus the supply voltage received by each processing core 110 is set and adjusted independently of the respective supply voltages received by other ones of processor cores 110. Thus, operating point adjustments that include adjustments of a supply voltage can be selectively applied to each processing core 110 independently of the others in implementations having non-shared voltage planes. In the case where changing the operating point includes changing an operating voltage for one or more processor cores 110, system management unit 125 changes the state of digital signals provided to voltage regulator 165. Responsive to the change in the signals, voltage regulator 165 adjusts the supply voltage provided to the affected ones of processor cores 110. In instances when power is to be removed from (i.e., gated) one of processor cores 110, system management unit 125 sets the state of corresponding ones of the signals to cause voltage regulator 165 to provide no power to the affected processing core 110.

In various implementations, computing system 100 can be a computer, laptop, mobile device, server, web server, cloud computing server, storage system, or any of various other types of computing systems or devices. It is noted that the number of components of computing system 100 and/or SoC 105 can vary from implementation to implementation. There can be more or fewer of each component/subcomponent than the number shown in FIG. 1. It is also noted that computing system 100 and/or SoC 105 can include other components not shown in FIG. 1. Additionally, in other implementations, computing system 100 and SoC 105 can be structured in other ways than shown in FIG. 1.

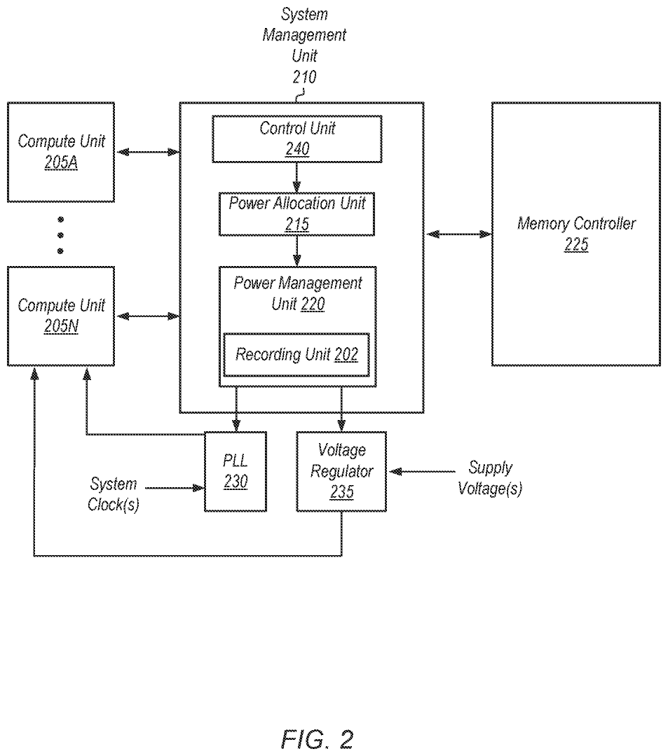

Turning now to FIG. 2, a block diagram of one implementation of a system management unit 210 is shown. System management unit 210 is coupled to compute units 205A-N, memory controller 225, phase-locked loop (PLL) unit 230, and voltage regulator 235. System management unit 210 can also be coupled to one or more other components not shown in FIG. 2. Compute units 205A-N are representative of any number and type of compute units (e.g., CPU, GPU, FPGA, etc.), and compute units 205A-N may also be referred to as processors or processing units. In some implementations, compute units include either or both of general purpose and special purpose computing circuitry. For example, in one implementation, at least one compute unit is a central processing unit (CPU) and another compute unit is a graphics processing unit (GPU).

System management unit 210 includes control unit 240, power allocation unit 215, and power management unit 220. In the example shown, the power management unit 220 is shown to include a recording unit 202. In some implementations, control unit 240 is configured to determine how power is allocated in the computing system. In one scenario, in response to detecting a particular condition, the control unit 240 determines a power budget allocation for various circuits within the computing system. In some implementations, system management unit 210 provides information to one or both of power allocation unit 215 and power management unit 220 for use in making power allocation decisions. Various such implementations and combinations are possible and are contemplated. In one scenario, the above-mentioned condition is a condition which requires a reduction in power consumption of the computing system (or some component(s) of the computing system). This condition may occur as a result of the system reaching a maximum allowed or allocated power. Alternatively, this condition may occur as a result of a thermal condition (e.g., a maximum operating temperature has been reached). In response to detecting the condition, control unit 240 evaluates a variety of parameters including one or more of the currently running task(s), types of tasks, phases of given tasks, and so on. In another scenario this condition may be enforced intentionally by some policy/mechanism implemented by the combined hardware and system software/firmware in an attempt to reach a desired software-dependent optimal operational point of the power performance setting. In various such implementations, certain attributes of the executing software application are tracked on the hardware as the software application is executing (at runtime) and are used to when making decisions taken at each point in time. It is noted that while power management unit 220 is shown to be included in the system management unit 210, in other implementations the power management unit 220 and/or recording unit 202 are located elsewhere. For example, in one implementation, the power management unit 220 and recording unit 202 are located with a graphics processing unit 140 or some other unit. In such a case, the graphics processing unit 140 is allocated a power budget by control unit 240 and power allocation unit 215, and operates to manage operating frequencies of circuitry within the graphics processing unit 140 within a given power budget. These and other implementations are possible and are contemplated.

Power allocation unit 215 is configured to allocate a power budget to each of compute units 205A-N, to a memory subsystem including memory controller 225, and/or to one or more other components. The total amount of power available to power allocation unit 215 to be dispersed to the components can be capped for the host system. Power allocation unit 215 receives various inputs from compute units 205A-N including a status of the miss status holding registers (MSHRs) of compute units 205A-N, the instruction execution rates of compute units 205A-N, the number of pending ready-to-execute instructions in compute units 205A-N, the instruction and data cache hit rates of compute units 205A-N, the consumed memory bandwidth, and/or one or more other input signals. Power allocation unit 215 can utilize these inputs to determine whether compute units 205A-N have tasks to execute, and then power allocation unit 215 can adjust the power budget allocated to compute units 205A-N (e.g., by control unit 240) according to these determinations. Power allocation unit 215 can also receive inputs from memory controller 225, with these inputs including the consumed memory bandwidth, number of total requests in the pending request queue, number of critical requests in the pending request queue, number of non-critical requests in the pending request queue, and/or one or more other input signals. Power allocation unit 215 can utilize the status of these inputs to determine the power budget that is allocated to the memory subsystem.

PLL unit 230 receives system clock signal(s) and includes any number of PLLs configured to generate and distribute corresponding clock signals to each of compute units 205A-N and to other components. Power management unit 220 is configured to convey control signals to PLL unit 230 to control the clock frequencies supplied to compute units 205A-N and to other components. Voltage regulator 235 provides a supply voltage to each of compute units 205A-N and to other components. Power management unit 220 is configured to convey control signals to voltage regulator 235 to control the voltages supplied to compute units 205A-N and to other components. Memory controller 225 is configured to control the memory (not shown) of the host computing system or apparatus. For example, memory controller 225 issues read, write, erase, refresh, and various other commands to the memory.

In an exemplary implementation, the power management unit 220 manages operating frequencies and power consumption for the system in a power management mode. For instance, in the power management mode, the power management unit 220 drops operating frequency of a computing unit that has low sensitivity (or relatively lower sensitivity to other computing units) to clock frequencies, in order to save power. For example, for a computing unit executing tasks that are compute-bound, the power management unit 220 increases the clock frequency to improve performance. On the other hand, for memory-bound tasks, the power management unit 220 does not increase the frequency given that such an increase does not result in an increased (or desired increase) in performance.

Recording unit 202 is configured to record one or more parameters associated with execution of a given task, such that these recorded parameters can be used by the power management unit 220 to manage power consumption of computing units for execution of subsequent tasks, based on the power budget determined by the power allocation unit 215. The recording unit 202, in one implementation, determines when the one or more parameters associated with the given task are to be recorded, based at least in part on an indication of a change in a characteristic of a set of tasks comprising the given task.

In an example, when the set of tasks comprises rendering of multiple frames, the recording unit 202 determines a need for recording parameters for a frame when the length of the frame (e.g., the amount of time it takes to render the frame, or the number of clock cycles to render the frame) exceeds that of a previously rendered frame. Further, the recording unit 202 triggers recording of the one or more parameters in response to detecting a recording condition, including but not limiting to, two or more consecutive frames taking a same (or similar) amount of time to render, two or more consecutive frames determined to have a same or similar average frequency used during rendering, rendering of two or more consecutive frames having a same or similar starting frequency, and the like.

In an implementation, the one or more parameters recorded by the recording unit 202 at least comprise operating frequencies. In an example, these operating frequencies are indicative of clock frequencies supplied to compute units 205A-N and to other components for executing a given task. The recording unit 202 is configured to record the operating frequencies used by a computing unit(s) while executing a given task and the power management unit 220 then utilizes the recorded operating frequencies to control clock frequencies supplied to one or more computing components for other subsequent tasks “relatively similar” to the given task. In a non-limiting example, when the given task comprises rendering of a frame, two frames are relatively similar if both frames are of the same length, are consecutive, or within a same scene.

Referring to the implementation of rendering of frames described above, an operating frequency used during rendering of a given portion of a frame is recorded and stored in the data array (or other data structure). A frequency used during the rendering of a corresponding portion of a frame is identifiable. For example, each such element of the data structure may be identifiable as corresponding to a portion of a frame and store a corresponding frequency. Then on the later frame, these recorded frequencies are used during the rendering of the later frame. Other implementations are contemplated.

In another implementation, the one or more parameters further comprise power states of a computing component while executing a given task, and sensitivity of the computing unit to changes in said power state. In an example, sensitivity of a computing unit to power changes may be indicative of how sensitive performance of the unit is to changes in power states, based on the types of tasks being executed, the types of units executing tasks, current operating frequency, current power consumption, as well as others. Based on recorded power states and sensitivity to changes in power state of a computing unit for a given task, the power management unit 220 manages power consumption of the computing unit for subsequent tasks relatively similar to the given task.

In one implementation, the system management unit 210 complements a power throttling unit (not shown) in managing power consumption for the computing components of SoC 105. In an example, the power throttling unit dictates amount of power (or operating frequencies) to be supplied to the computing components, when the SoC 105 is not operating in a power management mode (e.g., when the power management unit 220 is disabled, malfunctioning, or otherwise unavailable). For instance, when it is determined that recording of the one or more parameters associated with a given task is to be initiated, the power management unit 220 enters a mode of operation in which it does not change operating frequencies to manage power consumption (i.e., the power management mode of the unit is disabled). In the implementations described herein, the disablement of power management unit 220 and/or power management mode refers to disabling changes in operating frequencies of computing unit(s). For example, as discussed above, changing operating frequencies of circuitry associated with rendering frames is temporarily disabled. However, other power management functions such as dynamic power management of one or more GPU cores, GPU deep sleep functions, clock-gating, and the like may be active even when the power management unit 220 and/or the power management mode is disabled. That is, while the power management unit 220 is inactive, the control unit 240 and/or the power throttling unit can continue to determine how power is allocated in the computing system.

In an implementation, since the power management unit 220 is configured to save power in the power management mode, a computing unit executing a set of tasks may consume less power than it has been allocated by the power allocation unit 215. For instance, if the computing unit has been allocated a given power budget, the computing unit may end up consuming less power than has been allocated. For example, by throttling or otherwise limiting an operating frequency during rendering of frames, less than all of an allocated power budget is consumed than might otherwise be the case. In such a case, a power “credit” (i.e., unused power budget) is said to exist.

Further, in various implementations, when the power management mode is disabled, the computing unit consumes available power in order to maximize performance. In other words, if it is determined a power credit exists, this credit is reported to the given unit. In response to detecting that a power credit is available, the operating frequency of the given unit may increase in order to take advantage of the excess power that is available. In such an implementation, the given unit selects various operating frequencies based on reported available power. Such reported available power can represent currently unused power that has accumulated, or previously accumulated power that was unused. For instance, after the power management mode is disabled, and a power credit exists (e.g., allocated power remains available that permits operating at a higher frequency), the computing unit operates at operating frequencies that are closer to a maximum allowable frequency, rather than operating at throttled values of operating frequencies.

In order to identify operating frequencies that corresponds to non-power credit periods, one or more approaches are used. As will be described in greater detail, rendering of frames (or execution of the type of task being observed) is monitored. If a given condition is detected, then an assumption is made that any power credit that exists (or might have existed) has been consumed (or “drained”). For instance, when rendering frames, if a power credit exists, the operating frequency of a rendering unit may increase to a relatively high rate as discussed above. If power throttling is then disabled, the operating frequency will begin to decrease as the power credit is consumed. At some point in time, the operating frequencies will no longer reflect a power credit. In such a case, the rendering of similar frames will take a similar amount of time due to use of the same (or same average) frequency. Generally speaking, sequential frames often have a great deal of similarity. When a relatively significant change in rendering times between frames is detected, this often indicates a scene change. In addition to having a similar rendering time, such a condition can also be indicated if rendering of a first frame has a default starting frequency and the next frame is also rendered at the same starting frequency. Once such a condition is detected, these exemplary conditions for triggering the recording, in one implementation, can indicate that the operating frequencies have reached a relatively stable state after disablement of the power management mode. Other possible scenarios indicative of the operating frequencies reaching a relative stable state is contemplated.

The operating frequencies are then recorded and can serve as reference operating point(s) for the system management unit 210 to determine operating frequencies for execution of other subsequent tasks. Again, taking the example of rendering of frames as described above, the stable state is deemed to be reached when respective operating frequencies at the beginning of rendering of two consecutive frames is the same. The operating frequency for the second frame is then stored as the reference operating point.

Using these recorded parameters may advantageously facilitate efficient power saving, since the power credit being accumulated by the system management unit 210 is not immediately consumed as soon as it becomes available. Further, the system management unit 210 continues to manage power consumption based on the recorded frequencies, and the saved power may be used only for tasks for which increasing the power consumption results in a greater performance boost.

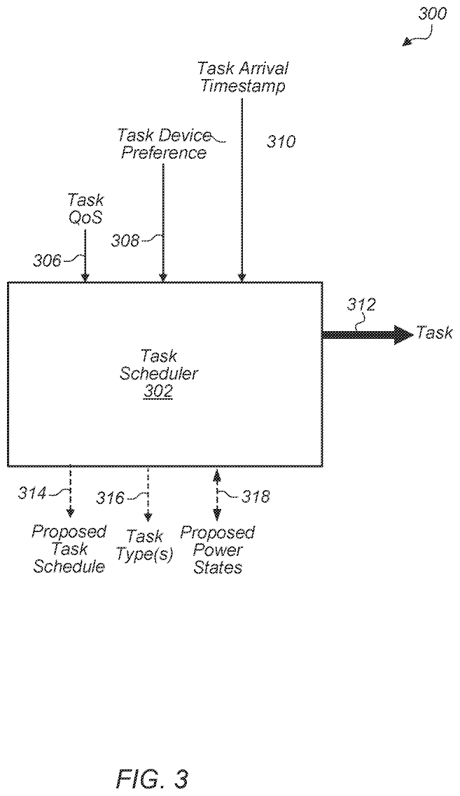

Referring now to FIG. 3, one implementation 300 of a task scheduler is shown. In one implementation, a task scheduler 302 assigns tasks from a task queue to a plurality of compute units of a SoC (e.g., SoC 105 of FIG. 1). The task scheduler 302 receives a plurality of inputs to use in determining how to schedule tasks to the various compute units of the SoC. The task scheduler 302 also coordinates with a system management unit (e.g., system management unit 210 of FIG. 2) to determine an optimal task schedule for the pending tasks to the compute units of the SoC. The plurality of inputs utilized by the task scheduler 302 includes quality of service (QOS) 306 requirement of the queued tasks, task arrival timestamp 310, and respective device preferences 308 (e.g., CPU, GPU). In other implementations, the task scheduler 302 utilizes other inputs to determine an optimal task schedule 314 for the pending tasks 312. In various implementations, information regarding proposed task schedules 314 and task types 316 is conveyed to, or otherwise make available to, system management unit 210.

In one implementation, the task scheduler 302 attempts to minimize execution time of the tasks on their assigned compute units and the wait time of the tasks such that the temperature increase of the compute units executing their assigned tasks stays below the temperature margin currently available. The task scheduler 302 also attempts to schedule tasks to keep the sum of the execution time of a given task plus the wait time of the given task less than or equal to the time indicated by the QoS setting of the given task. In other implementations, other examples of algorithms for a task scheduler are possible and are contemplated.

In another implementation, the system management unit 210 uses device preferences 308 to determine whether a given task is compute-bound or memory-bound. Further, the system management unit 210 ascertains the power state of a computing unit for executing the given task 312 from proposed power states 318. Based on the information on whether the task 312 is compute or memory bound, and the power state of the computing unit, the power allocation unit 215 allocates power for consumption by the computing unit, from the power budget, for executing the task 312. Based on the allocated power by the power allocation unit 215, and the devices preferences 308, the power management unit 220 is configured to manage the power supply for the computing unit, i.e., either by increasing the power supply, decreasing the power supply, or keeping the power supply constant.

In one example, when the power management unit 220 increases the power supply for the computing unit for executing the given task 312, a portion of the power credit accumulated previously is consumed. On the other hand, if the power supply is reduced, more power credit is accumulated. Further, stabilization of a power or frequency related parameter during execution of the task 312 is indicative of consumption of the power credit.

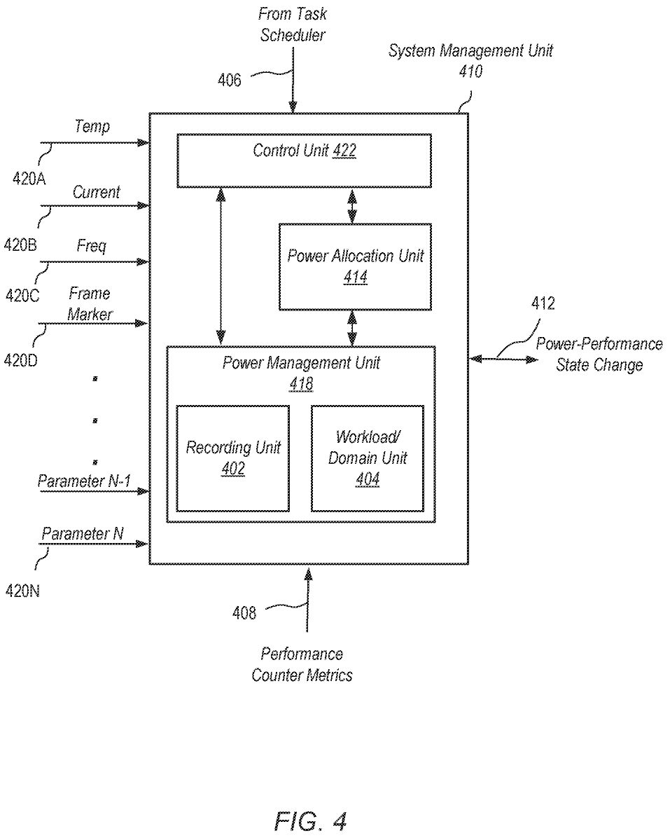

FIG. 4 illustrates a system management unit 410 that includes a control unit 422, power allocation unit 414, and power management unit 418. The power management unit further comprises a recording unit 402 and workload/domain unit 404. The control unit 422 is configured to determine how power is allocated in the computing system. Power allocation unit 414 is configured to allocate a power budget to one or more compute units (not shown), based at least in part on tasks received from the task scheduler 406. Further, power management unit 418 manages operating frequencies and power consumption for the system in a power management mode.

System management unit 410 is also shown as being configured to receive any number of various system parameters, shown as 420A-420N, that correspond to conditions, operations, or states of the system. In the example shown, the parameters are shown to include operating temperature 420A of a given unit(s), current drawn by given unit(s) 420B, operating frequency of a given unit(s) 420C, frame marker 420D (e.g., indicative of the beginning and end of a frame), and the like. Other parameters are possible and are contemplated. For example, in some implementations, one or more of the parameters 420 further comprise frame markers 420D comprising information pertaining to individual frames being rendered, such as frame lengths (e.g., the amount of time it takes to render a frame), frame performance markers, frame starting frequencies, and the like.

In various implementations, the one or more parameters are reported from other units or parts of a system (e.g., based on sensors, performance counters, other event/activity detection, or otherwise). In some implementations, one or more parameters are tracked within the system management unit 410. For example, system management unit 410 tracks current power-performance states of components within the system, duration(s) of power-performance state, previously recorded parameters, and so on. In addition, system management unit 410 is configured to receive task related information 406 from the task scheduler (e.g., Task scheduler 302 of FIG. 3). For example, such information may include proposed task schedules, task types, and proposed power states.

In the example of FIG. 4, workload/domain unit 404 comprises data indicative of the sensitivity of various portions of the computing system to changes in power states. In other implementations, workload/domain unit 404 is configured to calculate such data. For example, in one implementation, workload/domain unit 404 includes characterization data generated by executing various workloads and evaluating performance in relation to power state changes. In some implementations, this data includes characterization data generated offline. In other implementations, the data includes characterization generated at runtime. In still further implementations, characterization data maintained by the workload/domain unit 404 is programmable and may be updated during runtime based on a comparison of predicted power/performance changes compared to actual power/performance changes. In one implementation, workload/domain unit 504 includes circuitry configured to perform calculations representative of relationships between task types, power state changes, and predicted performance changes.

In some implementations, workload/domain unit 404 is further configured to determine how characteristics of a given task vary from previously executed tasks, in a given set of tasks. Any change in a given characteristic can indicate to the recording unit 402 that recording of one or more parameters for the given task is to be initiated. As mentioned in the foregoing, when the set of tasks comprises rendering of frames, the characteristics at least comprise a frame length and the one or more parameters at least comprise an operating frequency of a computing unit while executing the given task. The recording unit 402 can provide the recorded operating frequency to one or both of power allocation unit 414 and power management unit 418 for use in making power allocation decisions. Various such implementations and combinations are possible and are contemplated.

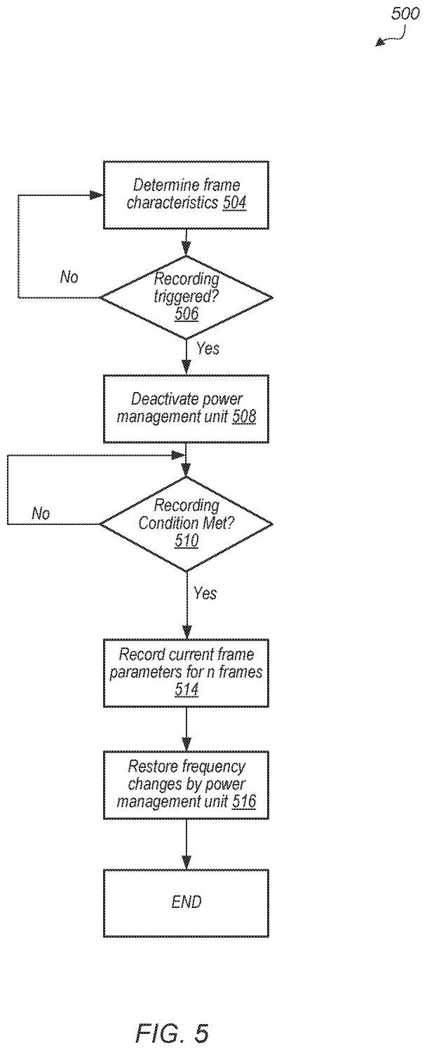

Turning now to FIG. 5, an exemplary method 500 for recording one or more parameters associated with a given task is illustrated. As described earlier, a system management unit (e.g., system management unit 410 of FIG. 4) is configured to record one or more parameters associated with execution of a given task. In an exemplary implementation, the recorded one or more parameters can be used by system management unit 410 manage power and performance parameters of one or more subsequent tasks. The system management unit 410 determines a change in a characteristic of a set of tasks, of which the given task is a part, and based on said change determine whether recording is to be triggered. Once determined that recording is to be triggered, a recording unit (e.g., recording unit 402 of FIG. 4) records the one or more parameters associated with the given task and store the recorded parameters in a data array. The recorded parameters are accessed by a power management unit (e.g., power management unit 418) to manage power and performance of one or more subsequent tasks. In an implementation, the one or more parameters at least comprise operating frequencies of computing unit(s) executing the set of tasks.

For the sake of brevity, the method 500 is described using an example wherein the set of tasks comprises a plurality of frames to be rendered by a computing unit, such that a given task represents rendering a distinct frame. Generally speaking, the method of FIG. 5 first determines when recording of task parameters in the absence of a power credit is to be performed. As described above, if the length of time to render frames changes by some threshold amount, which could be fixed or programmable, this may indicate a scene change has occurred. Consequently, any frequencies previously determined for rendering frames may no longer be suitable for the new scene(s). As such, new frequencies are determined for rendering subsequent frames. Further, a characteristic of the set of tasks inspected for change comprises the length of time it takes to render each frame, and the one or more parameters at least comprise an operating frequency of a given computing unit(s) rendering the frames. Other examples are contemplated.

A system management unit determines characteristics of each frame in a set of frames (block 504). In an implementation, the characteristic includes at least a length of time to render each frame. In an exemplary implementation, based on the determined length of each frame, the system management unit determines whether recording of operating frequencies associated with rendering of a given frame is to be triggered (conditional block 506). The determination of whether such recording is triggered is made by the system management unit, based at least in part on a detected change in the frame length of the given frame as compared to a previous frame(s). For instance, the system management unit determines that recording of the operating frequencies is triggered for a frame, when the length of the frame is different from that of an immediately preceding frame by a threshold amount. For example, if the frame length changes by 10% or more, than a scene change or other significant change is assumed to have occurred. In another example, the recording can also be deemed to be triggered when a predetermined period of time (e.g., 10 seconds) has elapsed during the rendering of the set of frames. In such a case, recording is triggered on a periodic basis (e.g., a programmable period of time).

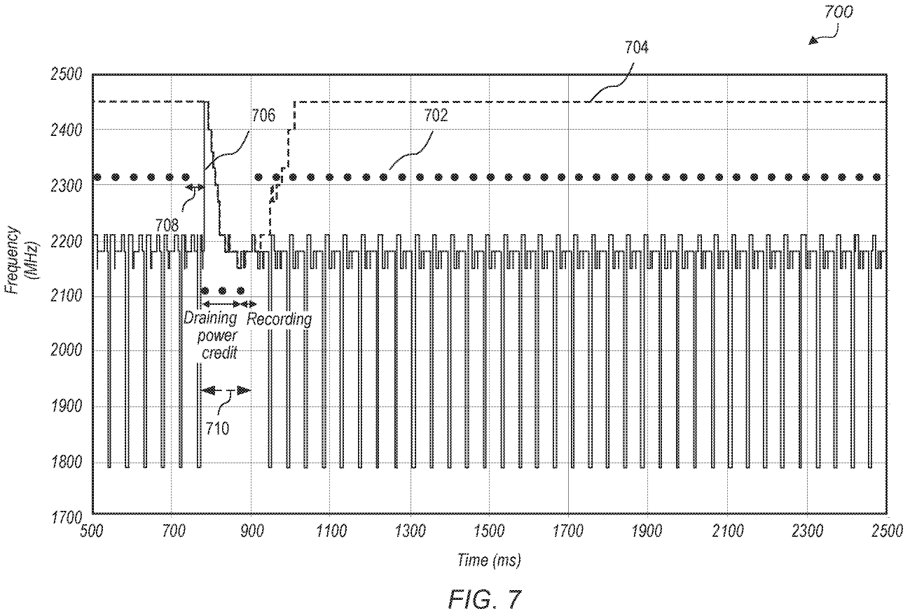

If it is determined that recording is not triggered (conditional block 506, “no” leg), the method 500 continues to block 504, wherein the system management unit continues to check for changes in characteristics of frames until such a change is determined and/or until a predetermined period of time is elapsed. Otherwise, if it is determined that recording of the operating frequencies associated with rendering of the given frame is triggered (conditional block 506, “yes” leg), the system management unit disables a power management unit such that frequency throttling is not performed (e.g., by power management unit 220) in order to reduce power consumption and potentially build or increase a power credit (block 508). Consequently, as will be described in relation to FIG. 7, any power credit that exists will be consumed.

The system management unit then determines whether a recording condition is met (conditional block 510). As described above, the recording condition comprises one or more scenarios, including but not limiting to, two or more consecutive frames taking a same (or similar) amount of time to render, two or more consecutive frames determined to have a same or similar average frequency used during rendering, rendering of two or more consecutive frames having a same or similar starting frequency, and the like. This suggests the operating frequency has reached a relatively stable state.

If it is determined that the recording condition is not met (conditional block 510, “no” leg), the system management unit inspects power consumption of the computing unit, wherein such consumption can indicate whether recording can be triggered. The system management unit, in an implementation, continues to monitor the power consumption for the computing unit to determine when to trigger the recording.

Once the recording condition is met (conditional block 510, “yes” leg), a recording unit records the operating frequency for the given frame (or in alternative implementations, for a given number of frames and/or a given period of time). In various implementations, the operating frequencies used during rendering of various portions of a frame are recorded. In an implementation, the recorded operating frequencies are stored (e.g., in a data array, memory location, etc.) and used by the power management unit to determine the operating frequencies to be used during rendering of other frames rendered subsequent to the given frame. The power management unit can also restore the power management unit once the recording is complete (block 516). The method 500 then ends.

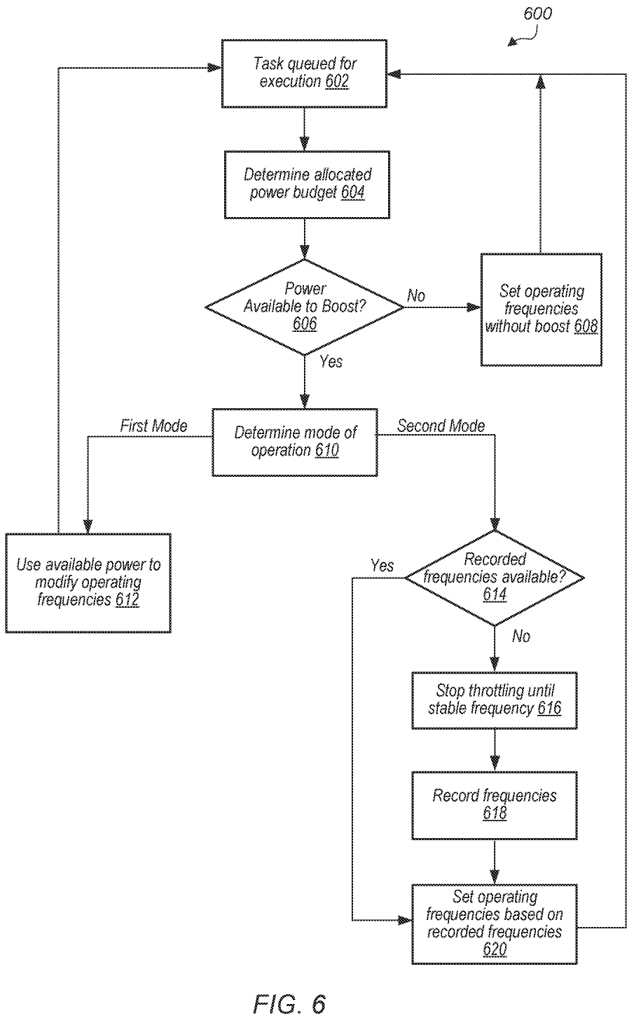

Although implementations presented with respect to FIG. 5 describe the power management unit identifying when a recording is triggered and begins recording when a recording condition is met, in other implementations the power management unit is configured to continuously record parameters of the frame (e.g., operating frequencies). In such a scenario, when the recording condition is met, the power management unit fetches the already recorded parameters for optimizing operating frequencies, as described in FIG. 6.

Turning now to FIG. 6, an exemplary method 600 for executing a task using one or more recording parameters is illustrated. As mentioned with regards to FIG. 5, a power management unit determines values for operating frequencies to be used by a computing unit to render one or more frames. In an example, the power management unit determines the operating frequencies for the rendering of a frame based on a power budget allocated to a computing unit scheduled to render the frames.

The power management unit, in an implementation, monitors one or more tasks queued for execution (block 602). As described in the foregoing, the tasks may comprise frames to be rendered by a given computing unit. Based on the tasks queued for execution at a given computing unit, or multiple computing units, the power management unit determines an allocated power budget for the computing unit(s) to execute a given task (block 604). For instance, when frames are being rendered, the power management unit can determine a power budget being allocated for the rendering. In one example, a graphics processing unit is allocated a power budget by a power allocation unit, and the power allocation unit is configured to operate to manage operating frequencies of circuitry within the graphics processing unit within the power budget.

The power management unit then determines, based at least in part on the power budget, whether excess power is available to boost the operating frequencies (conditional block 606). In an implementation, the available power is either accumulated or consumed as a power credit, e.g., when operating parameters of a processing system are adjusted by the power management unit in order to save power. For example, for execution of a task having low sensitivity to changes in operating frequency, the power management unit can decrease the operating frequencies during execution in order to save power. This saved power is an indication of an available power credit. In contrast, when a task having higher sensitivity to operating frequencies is executed, the power management unit can increase the operating frequencies to boost performance, and this may be an indication of consumption of a power credit.

If such excess power is not available (conditional block 606, “no” leg), the power management unit can set the operating frequencies without boosting (block 608). In an exemplary implementation, the power management unit is configured to set the operating frequency based on a performance sensitivity of the task currently being executed. However, if there is excess power available for boost (conditional block 606, “yes” leg), the power management unit determines a mode of operation. In an implementation, the power management unit is configured to operate in two modes of operation, wherein in the first mode of operation, the power management unit determines operating parameters for execution of a task based on available power (e.g., the power management mode). In the second mode of operation, the power management unit adjusts the operating parameters for a given task based at least in part on recording data available for other tasks relatively similar to the given task. For example, when the given task comprises rendering of a frame, two frames are relatively similar if both frames are of the same length, i.e., the time of execution for both frames is same.

As shown in the figure, when the first mode of operation is active, the power management unit changes the operating frequencies while the given task is being executed, based on the available power (block 612). For instance, responsive to determination that excess power is available, in the first mode, the power management unit boosts the operating frequency to a relatively higher level than current operating frequencies for potential performance increase. That is, the power management unit operates to boost performance to take advantage of a power credit when the computing unit executes tasks that are not performance sensitive.

On the other hand, if the second mode is active, i.e., the power management mode is active, the power management unit first determines whether recorded operating frequencies are available (conditional block 614). In an implementation, recorded operating frequencies can serve as reference operating points to determine operating frequencies for execution of a given task. For example, as described in the foregoing, operating frequencies can be identified and recorded during rendering of frames and subsequently used to set operating frequencies for rendering subsequent frames.

If recorded frequencies are available (conditional block 614, “yes” leg), the power management unit sets current operating frequencies based on these recorded frequencies. That is, using the recorded frequencies, the power management unit determines how current operating frequencies are to be modified, in order to save power or boost performance for the task being executed. For example, even when a power credit exists, instead of boosting the operating frequencies to maximum allowable frequency (as done in the first mode), the power management unit references the recorded frequencies to determine modifications to the operating frequencies. This could advantageously aid in generation of additional power credit, that can be utilized for performance sensitive tasks, i.e., for execution of tasks wherein increasing the power results in desirable performance enhancement.

If the recorded operating frequencies are not available (conditional block 614, “no” leg), the power management unit stops throttling of existing operating frequency levels until a stable operating frequency is reached (block 616). As described in the foregoing, the recording can be triggered responsive to change in length of time to render frames. When a relatively significant change in rendering times between frames is detected, this often indicates a scene change. In addition to having a similar rendering time, such a condition can also be indicated if rendering of a first frame has a default starting frequency and the next frame is also rendered at the same starting frequency. Once such a condition is detected, these exemplary conditions for triggering the recording, in one implementation, can indicate that the operating frequencies have reached a relatively stable state after disablement of the power management mode. Other possible scenarios indicative of the operating frequencies reaching a relative stable state is contemplated.

Once the stable frequency is reached, the power management unit records the operating frequencies (block 618). These recorded frequencies are then used as reference operating points to modify operating frequencies for subsequent tasks (block 620), as described above.

In an implementation, the power management unit continuously records operating frequencies for rendering of frames, when a condition for triggering the recording arises, e.g., change in length of the frame as compared to previously executed frames. Further, once the recording data is available, the power management unit uses the recorded data for execution of other frames, up until a point in the execution wherein the recording is required to be performed again. Further, each time the power management unit determines that operating frequency for rendering a given frame does not match the recorded operating frequency, the power management unit adjusts the operating frequency to match the recorded operating frequency (or modify the operating frequency using the recorded operating frequency as a threshold).

Turning now to FIG. 7, an exemplary timeline graph 700 depicting frequency (given in megahertz, MHz) modifications during rendering of a set of frames over a period of time (given in microseconds, ms) is illustrated. The figure depicts changes in operating frequency 706, during rendering of multiple frames 702, with respect to a maximum allowable frequency 704.

As shown, one such point in the execution where recording is initiated is shown by arrow 708. In an implementation, at the point 708 recording is initiated based on detecting a condition. In one implementation, the condition is a change in a length of time to render a frame(s) (also referred to as frame length). For example, at the point 708, the frame length changes by a given amount (e.g., e.g., 10%), which can initiate the recording. In various implementations, the given amount or condition is programmable. Responsive to the recording being initiated, the power management unit disables a power management unit, i.e., the computing unit(s) executing the set of frames 702 no longer operates in a power management mode.

Once the power management mode is disabled, the operating frequency 706 is no longer throttled and defaults to the maximum allowable frequency 704, as shown. As the operating frequency 706 increases, the computing unit consumes additional power (i.e., any power credit) that was previously saved due to throttling, and the operating frequency 706 gradually reaches a stable state. In one example, the stable state is indicated by two or more consecutive frames taking a same (or similar) amount of time to render, two or more consecutive frames determined to have a same or similar average frequency used during rendering, and/or rendering of two or more consecutive frames with a same or similar starting frequency. Once the stable state is achieved, it is assumed that any power credit previously accrued has been consumed. As depicted in the figure, when additional power (or “power credit”) is consumed during execution, a frequency increase due to additional available power dissipates and the operating frequency 706 drops.

Once the stable operating frequency is detected, the power management unit begins recording the operating frequency used to render frames. Further, the period of time in which the operating frequency is relatively stable, and the recording is performed, the power management mode remains disabled to ensure that no additional modifications to the operating frequency 706 are made. As shown in the figure, the power management mode is disabled for the time period shown by the arrow 710.

The recorded operating frequencies are then stored in a location accessible by the power management unit. Further, the power management unit (i.e., power management mode) may also be enabled once the recording is complete. The recorded operating frequencies are then used as a reference operating point for rendering of subsequent frames 702. As seen from the graph 700, after the recording is complete, rendering of the frames 702 continues at the stable state, without the operating frequency 706 rising to the maximum allowable frequency 704. This may in turn enable the power management unit to generate a power credit, whereas any additional power would have otherwise been consumed if the recorded operating frequency was not used as a reference operating point. For instance, the power management unit uses the recorded operating frequency to execute tasks where changes in operating frequency are relatively independent of the performance (i.e., tasks where performance has a lower sensitivity to change in frequencies). During such tasks, the power management unit continues to generate a power credit. Rather than boosting the operating frequency during rendering of frames to take advantage of the accumulated power credit, the recorded operating frequencies are used to render frames and the power credit can be used elsewhere where changes in operating frequency have a greater impact on change in the performance (i.e., on tasks where performance is more sensitive to change in frequencies).

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a system management unit configured to:
record one or more first operating frequencies of a computing unit while executing a first task; and
execute a second task with one or more second operating frequencies, wherein the one or more second operating frequencies are selected for executing the second task based at least in part on the one or more first operating frequencies.

2. The system as claimed in claim 1, wherein the first task comprises rendering a frame and the second task comprises rendering a frame.

3. The system as claimed in claim 2, wherein the one or more first operating frequencies are recorded responsive to a condition comprising detecting a scene change.

4. The system as recited in claim 3, wherein responsive to the condition, the system management unit is further configured to disable a power management mode for the computing unit until a stable operating frequency is achieved.

5. The system as recited in claim 1, wherein the system management unit is further configured to accumulate a power credit while operating in a power management mode.

6. The system as recited in claim 1, wherein the system management unit is further configured to record a power state associated with the computing unit.

7. The system as recited in claim 1, wherein the one or more first operating frequencies are recorded at predetermined periodic intervals.

8. A method comprising:
recording, by a system management unit, one or more first operating frequencies of a computing unit while executing a first task from a set of tasks; and
executing, by the system management unit, a second task from the set of tasks, with one or more second operating frequencies, wherein the one or more second operating frequencies are selected for executing the second task based at least in part on the one or more first operating frequencies.

9. The method as claimed in claim 8, wherein the first task comprises rendering a frame and the second task comprises rendering a frame.

10. The method as claimed in claim 8, wherein the one or more first operating frequencies are recorded responsive to identifying, by the system management unit, a change in at least one characteristic associated with the set of tasks, the at least one characteristic comprising at least a frame length.

11. The method as recited in claim 10, further comprising disabling, by the system management unit, a power management mode for the computing unit responsive to identifying the change in the at least one characteristic associated with the set of tasks.

12. The method as recited in claim 8, further comprising generating, by the system management unit, a power credit while executing the set of tasks.

13. The method as recited in claim 8, wherein the one or more second operating frequencies are operating frequencies that were recorded during execution of the first task.

14. The method as recited in claim 13, wherein the one or more first operating frequencies are recorded during a while a power management mode is enabled.

15. A computing system comprising:
a central processing unit;
a memory controller; and
a system management unit configured to:
record one or more first operating frequencies of a computing unit while executing a first task from a set of tasks; and
execute a second task from the set of tasks, with one or more second operating frequencies, wherein the one or more second operating frequencies are selected for executing the second task based at least in part on the one or more first operating frequencies.

16. The computing system as claimed in claim 15, wherein the first task comprises rendering a frame.

17. The computing system as claimed in claim 15, wherein the one or more first operating frequencies are recorded responsive to identifying a change in at least one characteristic associated with the set of tasks, the at least one characteristic comprising at least a frame length.

18. The computing system as recited in claim 17, wherein responsive to identifying the change in the at least one characteristic associated with the set of tasks, the system management unit is further configured to:
disable a power management mode for the computing unit; and
inspect consumption of a power credit as an indication that at least one operating frequency of the one or more first operating frequencies has reached a threshold value.

19. The computing system as recited in claim 15, wherein the system management unit is further configured to record a power state associated with the computing unit.

20. The computing system as recited in claim 15, wherein the one or more first operating frequencies are recorded at predetermined periodic intervals.
